(19) United States
(12) Patent Application Publication
(10) Pub. No.: US 2002/0153017 A1
(43) Pub. Date: Oct. 24, 2002

(54) Filters and method for producing filters

(76) Inventors: Nikolaos Georgitsis, Hamburg (DE); Sonke Horn, Geesthacht (DE)

Correspondence Address: VENABLE, BAETJER, HOWARD AND CIVILETTI, LLP, P.O. BOX 34385, WASHINGTON, DC, 20043-9998, US

(21) Appl. No.: 10/127,659

(22) Filed: Apr. 23, 2002

(30) Foreign Application Priority Data
Apr. 23, 2001 (DE) 101 19 820.5

(51) Int. Cl. B31C 13/00

(52) U.S. Cl. 131/331; 493/39; 131/365

(57) ABSTRACT

A filter for use in the tobacco processing industry includes a wrapping material section wrapped around filtering material and a covering paper section fitted around the wrapping material section. The covering paper section comprises at least one window and the wrapping material section is transparent, at least in some areas.

### CROSS-REFERENCE TO RELATED APPLICATION

This application claims the priority of German Patent Application No. 101 19 820.5, filed in Germany on Apr. 23, 2001. The disclosure of the above German priority application and the disclosures of each and every U.S. and foreign patent and patent application mentioned herein, are incorporated herein by reference.

### BACKGROUND OF THE INVENTION

The invention relates to the use of a wrapping material section to be wrapped around filtering material in the tobacco-processing industry. The invention also relates to a filter, and in particular a cigarette filter, with a wrapping material section for wrapping around the filtering material. The invention furthermore relates to a method for producing filters, particularly multi-filters, for products in the tobacco-processing industry.

Filters of this type are known, for example, from German Patent Application No. 101 05 011.9 and No. 101 05 010.0, and corresponding U.S. patent application Ser. No. 10/058,200 filed Jan. 29, 2002, all owned by the Assignee of the present application. These patent applications in particular disclose different methods and devices for producing multi-filters. The respective filters, namely the multi-filters, which are also called multisegment filters, consist of at least two filter elements and typically up to 8 filter elements, arranged in an optional sequence. Different filter elements or segments are arranged inside a tubular sleeve. These can include soft-filter elements such as cellulose acetate, paper, non-woven or relatively hard filter elements such as granulate, sintered elements, hollow-cylindrical or hollow chamber elements and capsules or the like. The respective filtering materials do not have to be composed completely (100%) of a single type of material. They can also be composed of mixed materials, for example granulate in a cellulose acetate, wherein granulate materials, such as active charcoal in particular, are considered. Individual multi-filters with the most varied filtering characteristics can be produced, depending on the materials used and the sequence in which the filter segments are arranged. These multi-filters are advantageously attached to the end of a rod-shaped article in the tobacco-processing industry and especially to the ends of tobacco rods. To accelerate the production of filters of this type for products in the tobacco-processing industry, a method for producing multi-filters has been suggested, which among other things, includes supplying a filter sleeve in a predetermined position making it possible to insert predetermined portions or pre-selected amounts of filtering material. According to German Patent Application No. 101 05 011.9, multiple filtering material portions are transferred simultaneously, and according to German Patent Application No. 101 05 010.0, prefabricated filter sleeves containing a filtering material are used.

A filter comprising several sections is known from British Patent No. 2 101 466 A, wherein one section does not contain filtering material and wherein openings are provided in the filter wrapping paper to increase ventilation by feeding in ventilation air.

### SUMMARY OF THE INVENTION

It is an object of the present invention to modify a filter-production method as described above, such that the filter production can be further accelerated.

Another object is to produce filters that are relatively stable against mechanical stresses, making it possible for an observer or smoker to view the type of filtering materials used, at least in some sections.

This object is achieved by a method according to the invention of using a wrapping material section, which is transparent in at least some areas and is wrapped around the filtering material, particularly a filter or multi-filter used in the tobacco-processing industry. The use according to the invention of a transparent wrapping material section allows the smoker to view the filtering materials at least in some parts or areas, while these materials are simultaneously kept relatively stable.

A multi-filter for the purpose of this invention is understood to be a multisegment filter, wherein the filter comprises at least two segments. The segments can be composed of different types of materials, such as cellulose acetate, paper, non-woven, granulate, sintered elements, hollow-cylindrical or hollow chamber elements, capsules, and the like.

If the wrapping material section is advantageously wrapped directly around the filtering material, a particularly good confinement of the filtering materials and extremely high filter stability are possible. If a covering paper provided with at least one window is additionally fitted around the wrapping material section, the smoker can view the filtering materials without removing at least a portion of the covering paper. The at least one window preferably overlaps an area of the wrapping material section that is transparent. The design and production of filters of this type is particularly easy if the wrapping material section is a heat-shrinking sleeve or foil, which results in an especially stable filter.

According to a further aspect of the invention, there is provided a filter, particularly a cigarette filter, having a wrapping material section for wrapping around the filtering material and a covering paper section, which is fitted around the wrapping material section, wherein the covering paper section comprises at least one window. The filter is modified in that the wrapping material section is designed to have at least some transparent areas. The filter design according to the invention allows the observer or smoker to view the filtering materials used, at least in some sections. For this, the at least one window and the transparent areas in the wrapping material section are advantageously arranged one above the other.

For the purpose of this invention, the term “transparent” is also understood to mean “semi-transparent” and “opaque” and can furthermore include the appearance of milky glass, meaning a milky transparency. The term “window,” in particular, is understood to mean an opening, but can also refer to a transparent region, e.g. a foil section is provided in the area of the opening in the covering paper section. This foil section is respectively connected to or glued to the covering paper. Within the framework of this invention, the term window also refers to an area of the covering paper section that can be pulled off mechanically, meaning a region that is surrounded by a perforation resulting in a weakening line. A window can also be an opening initially covered with a cover sheet, e.g. attached with glue to a covering paper section, which can subsequently be pulled off by a person.

It is advantageous if the wrapping material section is in part imprinted, thus making it possible to prevent an observer from viewing the filtering material areas that are discolored as a result of nicotine or condensate. These areas can be imprinted, for example, with a color that matches the filtering material, so as to give the impression that the filtering material itself is not discolored.

The at least one window advantageously takes the shape of one or several openings or is formed with a transparent material. The filter preferably is a multisegment filter having at least two segments with different filtering materials. The nicotine values and condensate values of the cigarette with filter can be reduced by designing the wrapping material section and, if necessary, the covering paper such that it has a perforation or is air permeable, at least in some sections.

According to another embodiment of the invention there is provided a filter, particularly a cigarette filter, having a wrapping material section that is wrapped around filtering material, wherein the filter in part has the previously described features and is modified through the use of a foil material. Extremely stable filters can be produced if a foil material is used, which is preferably partially transparent or semi-transparent.

The filter production is greatly simplified if the foil material is advantageously a heat-shrinking material. The wrapping material section preferably is a heat-shrinking sleeve, which results in an especially elegant production method and a particularly stable filter.

According to another aspect of the invention, there is provided a rod-shaped article in the tobacco-processing industry, particularly a cigarette, comprising a filter as described above.

According to still another aspect of the invention, there is provided a method for producing filters, particularly multi-filters, for products in the tobacco-processing industry, which method includes the following steps:

(a) supplying a filter sleeve that is transparent in at least some sections; and

(b) inserting predetermined amounts of filtering material into the filter sleeve.

With the method according to the invention, filters can be produced in a simple and effective manner. These filters make it possible to inspect or see the filtering materials, at least in some sections, while simultaneously permitting the production of an extremely stable filter.

The filter sleeve advantageously is and/or will be perforated, at least in some sections. Standard perforation techniques, for example employing laser beams, are advantageously used to perforate the filter sleeve. For this, reference is made to German Patent No. 41 08 166 A1 owned by the Assignee of the present application.

According to another embodiment of the invention, there is provided a method for producing filters, particularly multi-filters, for products in the tobacco-processing industry, in part having the features of the previously mentioned method according to the invention, which involves the following steps:

(a) supplying a filter sleeve provided with foil material; and

(b) inserting predetermined amounts of filtering material into the filter sleeve.

By providing or supplying a filter sleeve that comprises foil material, it is possible in an elegant and simple manner to produce an extremely stable filter. In addition, if the foil material is transparent or semi-transparent, it will also ensure a view of the filtering material.

A particularly simple and effective realization of the method is possible if the foil material advantageously is a heat-shrinking foil, especially a heat-shrinking sleeve, and if this heat-shrinking foil is shrunk at least in part during an additional operational step. The step of shrinking the foil is advantageously carried out following the complete filling of the filter sleeve, wherein the at least partial shrinking step requires that at least a portion of the foil be heated.

Following that, a covering paper section with at least one window is preferably fitted around the filter sleeve. For example, a covering paper section can be fitted around the filter sleeve or around the completely finished filter with a tobacco rod attached to one end, or can be fitted on during the production of double-length filters with tobacco rods on both ends, which are wrapped with cigarette paper. If double-length filters are produced, these are cut in the center following the production and fitting on of the covering paper.

The window advantageously is an opening or is transparent or is located in a region already provided with at least one weakening line, which can then be pulled off by the smoker. A cover sheet can also be provided, which is connected, e.g. glued, to the covering paper section in the window area and can be pulled off by the smoker.

### BRIEF DESCRIPTION OF THE DRAWINGS

In the following, the invention is described with exemplary embodiments and without limiting the general inventive idea by referring to the drawings to which reference is made for all other details of the invention, not further described in the text.

FIGS. 1(a) to 1(g) show schematically 7 variations of a respective cigarette with multisegment filters or multi-filters, wherein:

FIG. 1a) shows a multisegment filter without covering paper;

FIG. 1b) shows a multisegment filter with covering paper;

FIG. 1c) shows a multisegment filter with a window in the covering paper;

FIGS. 1d) and 1e) show a multisegment filter with several windows in the covering paper;

FIG. 1f) shows a multisegment filter with tear-off window in the covering paper; and

FIG. 1g) shows a multisegment filter with a tear-off window that is already pulled off or with a permanent window and imprinted wrapping film or heat-shrinking sleeve inside the covering paper.

FIG. 2 shows schematically a sectional representation of a transfer station for the filter production, showing an operational stage where more than half of the filter sleeve is filled.

### DETAILED DESCRIPTION OF THE INVENTION

In the following, the same elements are given the same reference numerals, so that the respective elements will not be presented anew.

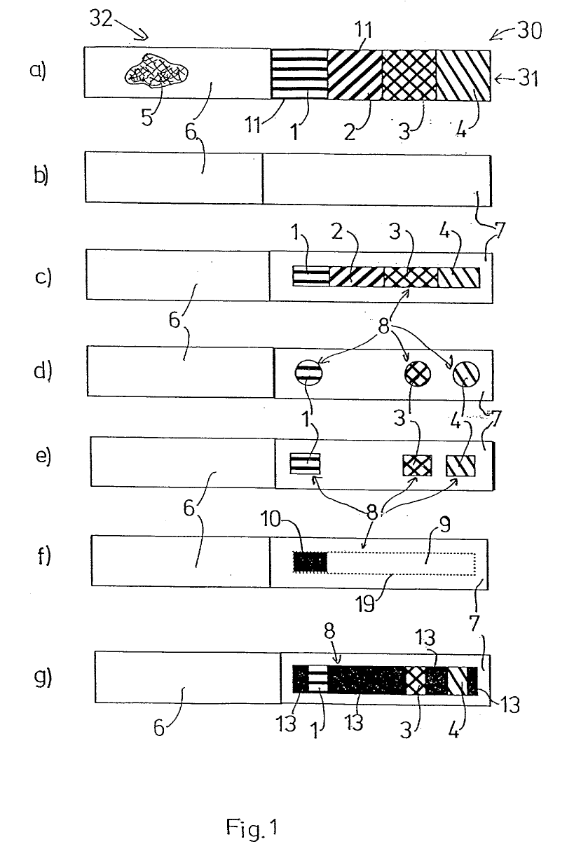

FIG. 1a) schematically shows a cigarette 30, comprising a filter 31 and a tobacco rod 32. The tobacco rod 32 contains tobacco 5 around which the cigarette paper 6 is wrapped. The filter is composed of four types of filtering materials 1 to 4, which are enveloped by a heat-shrinking sleeve or foil 11. The four filtering materials 1 to 4 are inserted into the heat-shrinking sleeve 11 during the filter production. Heat is subsequently applied to the sleeve, which causes the sleeve to shrink so that the filtering materials are compacted accordingly or are arranged immovably inside the heat-shrinking sleeve.

In FIG. 1a), the first filtering material 1 can consist, for example, of a non-woven material while the second filtering material 2 and the third filtering material 3 can consist of different types of granules. In contrast, the fourth filtering material 4 can be a cellulose acetate, so that the tactile area in the mouth region of the filter can be provided with a design known to the smoker. FIG. 1a) already represents an embodiment of a filter or cigarette according to the invention. The tobacco 5 in FIG. 1a), however, is visible only after tearing open the cigarette paper 6. For this embodiment, the tobacco 5 is shown only schematically for explanatory purposes.

FIG. 1b) shows a cigarette that appears to be standard when seen from the outside, wherein this cigarette also comprises the heat-shrinking sleeve 11 underneath the covering paper 7. However, this foil is not visible in FIG. 1b) since the covering paper 7 covers the sleeve. A different type of foil that is not designed to shrink when heat is applied can also be used in place of the heat-shrinking sleeve 11.

FIG. 1c) shows an embodiment of the filter according to the invention, which is provided with a window in the covering paper 7. Parts of the four filtering materials 1 to 4 are visible as a result of this window, which can be an opening in the covering paper 7 or can be closed off by a transparent material.

FIG. 1d) shows three windows 8 with a round design, whereas FIG. 1e) shows three windows with a rectangular design in the filter region. It is obvious that not all the filtering materials are visible. In the embodiments of FIGS. 1d) and 1e), the second filtering material 2 is covered.

The filter or covering paper 7 shown in FIG. 1f) is provided with a window 8, designed as a tear-off window 9, for which a perforation 19 or a weakening line 19 is provided. A consumer can pull off this tear-off window 9 by gripping the material or by gripping the tear-off strip 10.

FIG. 1g) shows a multisegment filter with an open window, for example, a pulled-off window or a permanent window, wherein the heat-shrinking sleeve 11 is provided with imprinted regions 13. For example, if the second filtering material 2 is a cellulose acetate, it is advantageously possible to make this region not visible to the observer by printing on it, so that the observer does not detect the discoloration of the cellulose acetate during smoking. It is also possible to use only a partially transparent foil or a heat-shrinking sleeve 11. The paper sleeve or the covering paper 7 can advantageously be provided with a built-in or glued on transparent foil as a window.

The heat-shrinking sleeve or foil 11 preferably consists of polyethylene (PE) or components of a natural polysaccharide or polyolefin or PVC [polyvinyl chloride]. Materials of this type are known from German Patent document DE OS 24 29 783, which corresponds to U.S. Pat. No. 4,129,134.

The heat-shrinking sleeve or foil 11 surrounding the multisegment filter or filters is (are) preferably made from a biodegradable material. Completely biodegradable filters can consequently be produced if the filtering materials additionally are also biodegradable.

The window in the covering paper can either be produced ahead of time and pulled from a bobbin or can be produced online in a filter-production machine, e.g. by providing weakening lines or removing the complete window with laser beams or by cutting them out with knives. The window can be an opening or a hole in the covering paper, or it can be a covered opening that is opened by the consumer. For this, the window is pre-perforated or closed off with a cover strip.

As described in the above, reference is made in particular to the aforementioned German Patent Application Nos. 101 05 11.9 and 101 05 10.0 and corresponding U.S. patent application Ser. No. 10/058,200 which can be used for producing filters of this type.

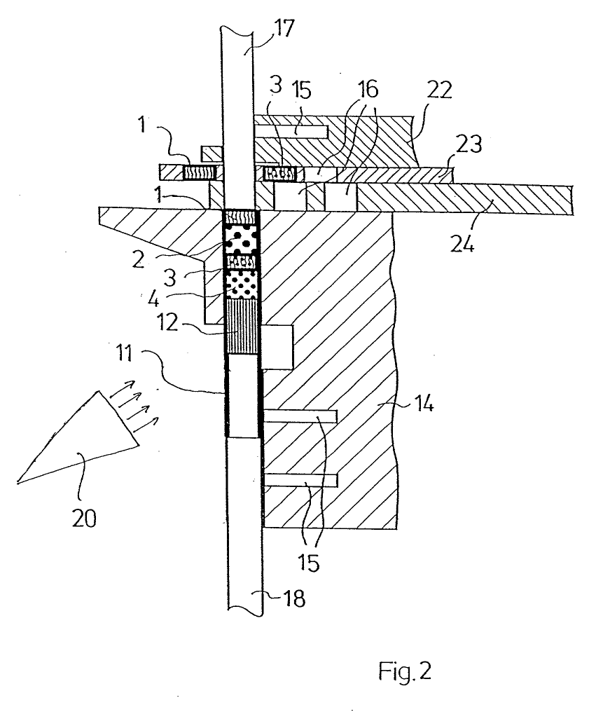

The schematic sectional representation in FIG. 2 shows a station for transferring filtering materials into a heat-shrinking sleeve 11. The heat-shrinking sleeve 11 is supplied during a previous operational step to a conveyor drum 14, which then holds the heat-shrinking sleeve 11 with the aid of vacuum bores and suction air in a lower position, not shown in FIG. 2, on the conveying drum 14. In a following operational step, the heat-shrinking sleeve 11 is moved to an upper position with the aid of a lower plunger 18, which can be inserted up to the filter plug 12 into the heat-shrinking sleeve 11. In this upper position, the filtering materials 1 to 4 are then inserted with an upper plunger 17. During an earlier step, the filtering materials were filled into the respective bores 16. By moving the respective first pusher 23 and the second pusher 24, such that they are aligned with the heat-shrinking sleeve 11, it is possible to insert the respective filtering materials with the aid of the upper plunger. Respectively two segments with filtering materials are inserted for this exemplary embodiment. By means of the filter plug drum 22 and the vacuum bores 15 in this drum, corresponding filter plugs are supplied, which are first cut in half and then inserted into the first pusher 23.

With respect to filling the heat-shrinking sleeve 11 or a filter sleeve 11, reference is again made to the complete content of the aforementioned German Patent Applications Nos. 101 05 11.9 and 101 05 10.0, and their U.S. counterpart, U.S. patent application Ser. No. 10/058,200, as explained above.

FIG. 2 furthermore schematically shows a radiant heater 20, which supplies hot air to at least a portion of the heat-shrinking sleeve 11 after it is filled completely or partially as indicated in FIG. 2. For this exemplary embodiment, hot air is advantageously supplied only to the upper region, to prevent shrinking of the lower region of the heat-shrinking sleeve, which is not yet filled with filtering materials.

Before turning the half-filled heat-shrinking sleeve 11 over for further filling, it is advantageous if hot air is supplied to the already filled section of the heat-shrinking sleeve. This is to ensure that the filtering materials no longer can fall out of the heat-shrinking sleeve. As a result of this measure, fewer holding elements are needed on the filter-filling machine.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A method of making a filter in the tobacco-processing industry, comprising: providing a wrapping material section that is transparent in at least some areas and wrapping said wrapping material section around filtering material.

2. The method according to claim 1, wherein the wrapping step includes wrapping the wrapping material section directly around the filtering material.

3. The method according to claim 1, further including fitting a covering paper provided with at least one window around the wrapping material section.

4. The method according to claim 1, wherein the wrapping material section is a heat-shrinking sleeve.

5. The method according to claim 1, wherein the filter is a multisegment filter.

6. A filter for use in the tobacco processing industry, comprising:
filtering material;
a wrapping material section wrapped around the filtering material; and
a covering paper section fitted around the wrapping material section;
wherein the covering paper section comprises at least one window and the wrapping material section is transparent, at least in some areas.

7. The filter according to claim 6, wherein at least some portions of the wrapping material section are imprinted.

8. The filter according to claim 6, wherein the at least one window comprise one of (a) at least one opening, and (b) a transparent material.

9. The filter according to claim 6, wherein the filter is a multisegment filter, comprising at least two segments with different filtering materials.

10. The filter according to claim 6, wherein at least some areas of the wrapping material section are perforated or are air permeable.

11. A filter for use in the tobacco processing industry, comprising:
filtering material;
a wrapping material section wrapped around the filtering material, wherein the wrapping material section comprises a foil material.

12. The filter according to claim 11, wherein the filtering material is a material that shrinks under the effect of heat.

13. The filter according to claim 11, wherein the wrapping material section is a heat-shrinking sleeve.

14. A rod-shaped article in the tobacco-processing industry including a filter according to claim 6.

15. A method for producing filters for products in the tobacco-processing industry, comprising:
supplying a filter sleeve having at least some transparent sections; and
inserting predetermined amounts of filtering material into the filter sleeve.

16. The method according to claim 15, including perforating the filter sleeve in at least some sections.

17. The method according to claim 16, wherein the perforating step occurs prior to the supplying step.

18. The method according to claim 16, wherein the perforating step occurs after the supplying step.

19. A method for producing filters for products in the tobacco-processing industry, comprising:
supplying a filter sleeve made of a foil material; and
inserting predetermined amounts of filtering material into the filter sleeve.

20. The method according to claim 19, wherein the foil material is a heat-shrinking foil and the method includes heating the heat-shrinking foil, at least partially, during an additional operational step.

21. The method according to claim 20, wherein the step of heating the heat-shrinking foil occurs after the filter sleeve is filled completely with filtering material.

22. The method according to claim 15, including fitting a covering paper section with at least one window around the filter sleeve.
